(19) United States
(12) Patent Application Publication
(10) Pub. No.: US 2021/0183127 A1
(43) Pub. Date: Jun. 17, 2021

(54) SYSTEM FOR PERFORMING REAL-TIME PARALLEL RENDERING OF MOTION CAPTURE IMAGE BY USING GPU

(71) Applicants: EIFENINTERACTIVE CO., LTD, Seeoul (KR); HOLOWORKS INC., Seeoul (KR)

(72) Inventor: Do Kwun KWON, Seoul (KR)

(21) Appl. No.: 17/256,374

(22) PCT Filed: Jun. 29, 2018
(86) PCT No.: PCT/KR2018/007439

§ 371 Date: Dec. 28, 2020

(30) Foreign Application Priority Data
Jun. 29, 2018 (KR) 10-2018-0075741

(51) Int. Cl. G06T 13/20; G06T 15/00; G06T 1/20

(52) U.S. Cl. CPC G06T 13/20; G06T 1/20; G06T 15/005

(57) ABSTRACT

The present invention relates to a system for performing real-time parallel rendering of a motion capture image by using a GPU, and relates to a system which performs real-time rendering of an image obtained by motion capturing, so as to reduce a time required for output of the image to an output device, such as a hologram, and thus enable real-time interactions.

### TECHNICAL FIELD

The present invention relates to a system for performing real-time rendering of a motion capture image, and more particularly, to a system for performing real-time rendering of a motion capture image through parallel tasks of a graphics processing unit (GPU).

### BACKGROUND ART

The physically based rendering that can generate photorealistic images is a standardized color calculation method for calculating a final color value by substituting an optically based rendering parameter into a rendering equation. As can be seen from comparison between a shader and Phong shader in which the physically based rendering is applied using open source three-dimensional (3D) game engines, the physically based rendering is a method in which physical values of a photorealistic image are applied to the rendering. Nowadays, the necessity of developing a graphics processing unit (GPU)-based rendering technique has emerged for photorealistic image reproduction and interaction. The GPU-based rendering technique is an essential technique for producing photorealistic scenes in real time and is recently being applied to major game engines (e.g., Unreal 4, Fox, and Unity 5), and advanced techniques are continuously being equipped. To this end, high-performance GPU functions are maximally utilized, but the importance of developing a high-quality rendering service technique is recognized and the application of the physical-based rendering technique is being accelerated. The game industry also recognizes the importance of the physically based rendering and continues to announce engines equipped with the physically based rendering in order to reproduce photorealistic images, but techniques for real-time interactions of a photorealistic computer graphics (CG) character of a real person have not been developed.

### DISCLOSURE

### Technical Problem

The present invention is directed to providing a system capable of interactions.

The present invention is also directed to providing a system capable of performing real-time rendering through graphics processing unit (GPU) calculation.

### Technical Solution

One aspect of the present invention provides an interactive high-quality system based on real-time parallel rendering. The system includes an output unit (200) including a plurality of image output units, a graphics processing unit (GPU) parallel calculation module (100) including a plurality of parallel rendering devices connected to correspond to the plurality of image output units, and a motion capture unit (300), which generates motion information by recognizing a motion of a user and transmits the generated motion information to the GPU parallel calculation module (100). In the GPU parallel calculation module (100), one specific render calculation unit of a plurality of render calculation units is configured as a server and the remaining render calculation units are configured as clients. The image output units are installed so that boundaries of screens thereof are in contact with each other, and thus the output unit (200) forms a single large screen. The render calculation unit includes a database (DB) (160) in which a three-dimensional (3D) image object (500) and segmented region information (600) are stored, an image object loading unit (110) which loads the 3D image object (500) stored in the DB (160), a segmentation and loading unit (120) which loads the segmented region information (600) stored in the DB (160), a motion processing module (130) which receives the motion information to load motion command information matched with the corresponding motion information from the DB (160), a rendering unit (140) which segments the 3D image object (500) according to the segmented region information (600) and renders the 3D image object segmented based on motion command information (700), and a segmented content transmission unit (150) which transmits the segmented 3D image object rendered by the rendering unit (140) to the image output unit connected to the render calculation unit. The rendering unit (140) includes a screen splitter (141) which extracts the 3D image object segmented into a rectangular region composed of coordinates of the segmented region information (600) when a center of the 3D image object (500) is set as a point of origin, a motion command information processing unit (142) which generates rendering information for rendering the 3D image object based on the motion command information (700), a synchronization unit (143) which transmits the rendering information generated by the motion command information processing unit (142) to the server when the render calculation unit is the client and which transmits the rendering information generated by the motion command information processing unit (142) or the rendering information transmitted from another render calculation unit to the remaining render calculation units when the render calculation unit is the server, and a GPU parallel processing unit (143) which renders the 3D image object (500) in a parallel GPU computing method using the rendering information transmitted by the synchronization unit (143). The segmented region information (600) is composed of 3D coordinates for three of four corners on the screen of the image output unit connected to the render calculation unit when a central point on the screen of the image output unit located at a center of the output unit (200) is a point of origin.

### Advantageous Effects

According to the present invention, a motion capture image can be rendered in real time.

Further, content can be produced using a hologram or the like from the image rendered as described above.

Further, ultra-high resolution three-dimensional (3D) image content can be rendered in real time using a parallel graphics processing unit (GPU) computing technique, and a system that enables interactions through recognition of a motion of a user can be provided, thereby improving immersion.

### DESCRIPTION OF DRAWINGS

FIG. 1 is a block diagram of an overall configuration of a system for performing real-time parallel rendering of a motion capture image using a graphics processing unit (GPU) according to the present invention.

FIG. 2 is a block diagram of components of a parallel rendering device among components of the system for performing real-time parallel rendering of the motion capture image using the GPU according to the present invention.

FIG. 3 is a configuration diagram of a system for performing real-time parallel rendering of a motion capture image using a GPU according to an embodiment of the present invention.

FIG. 4 is a configuration diagram of a system for performing real-time parallel rendering of a motion capture image using a GPU according to another embodiment of the present invention.

### BEST MODE OF THE INVENTION

A system for performing real-time parallel rendering of a motion capture image using a graphics processing unit (GPU) is provided.

### Modes of the Invention

Hereinafter, embodiments of the present invention that can be easily performed by those skilled in the art will be described in detail with reference to the accompanying drawings. However, the present invention may be implemented in several different forms and is not limited to the embodiments described below. In addition, parts irrelevant to description are omitted in the drawings in order to clearly describe the embodiments of the present invention. The same or similar parts are denoted by the same or similar components in the drawings.

Objects and effects of the present invention may be naturally understood or may become more apparent from the following description and the objects and effects of the present invention are not limited only by the following description.

The objects, features, and advantages of the present invention will become more apparent from the following detailed description. Further, in descriptions of the present invention, when detailed descriptions of related known configurations or functions are deemed to unnecessarily obscure the gist of the present invention, they will be omitted. Hereinafter, the embodiments of the present invention will be described in detail with reference to the accompanying drawings.

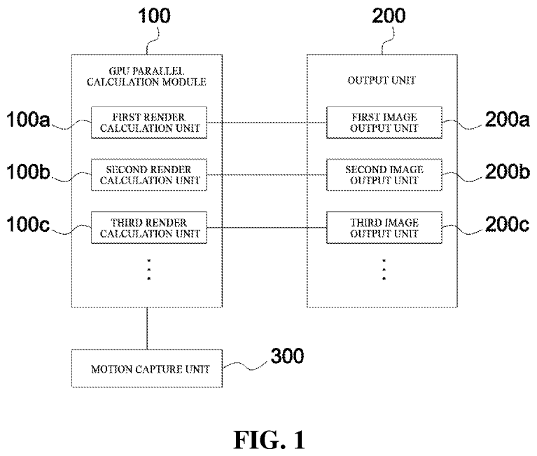

The present invention relates to a high-quality interactive system based on real-time parallel rendering, and the system includes a graphics processing unit (GPU) parallel calculation module 100, an output unit 200, and a motion capture unit 300 as illustrated in FIG. 1.

The output unit 200 includes a plurality of image output units 200a, 200b, 200c, . . . , and the output unit 200 serves to output one three-dimensional (3D) image object 500 by connecting all of a plurality of image output units that output segmented 3D image objects.

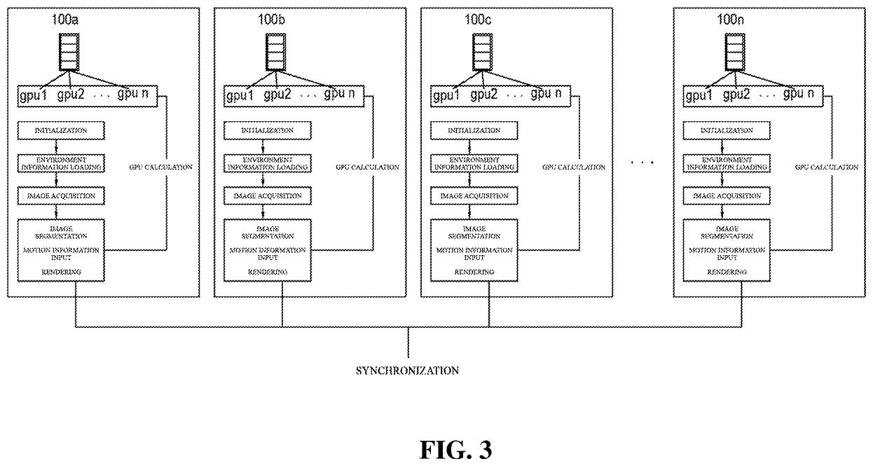

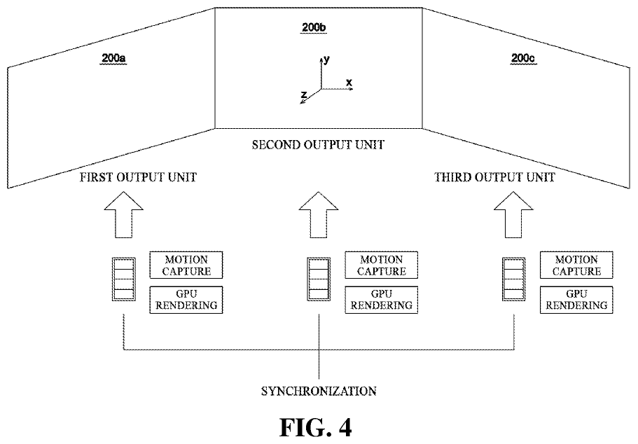

In particular, the image output units are installed so that boundaries of screens of the image output units are in contact with each other, and thus the output unit 200 forms a single large screen. For example, when light-emitting diode (LED) displays and/or liquid-crystal displays (LCDs) are connected in a grid type (see FIG. 3), a horizontal line (see FIG. 4), or a vertical line, each display may be the image output unit, and when a plurality of screens are connected in a grid type, a horizontal line, or a vertical line and a plurality of projectors shoot segmented images on the screens, a combination of each projector and a corresponding screen may be the image output unit. However, the “line” means that the image output units are connected to one line when viewed from the front and that the connected displays are bent (see FIG. 4) when viewed from a different direction (viewed from above or from the side, etc.). In addition, the screens are connected in four or multiple angles to surround a front side of the output unit 200 so that a space in which the 3D image object 500 is output may be formed.

The motion capture unit 300 may serve to generate motion information by recognizing a motion of a user and transmit the generated motion information to the GPU parallel calculation module 100, and the motion capture unit 300 may recognize a user's gaze, hand motion, body motion, etc. within a space provided in the output unit 200 using a Kinect sensor or the like.

The GPU parallel calculation module 100 includes a plurality of render calculation units 100a, 100b, 100c, . . . that are connected to correspond to the plurality of image output units 200a, 200b, 200c, . . . . That is, the image output units and the render calculation units are connected in one-to-one correspondence with each other.

In this case, one specific render calculation unit 100a among the plurality of render calculation units 100a, 100b, 100c, . . . , which are connected to each other via a network, is designated as a server and the remaining render calculation units 100b, 100c, . . . are designated as clients. The above configuration is for synchronization of rendering to be described below.

In the render calculation unit 100a, the 3D image object 500 and segmented region information 600 consisting of coordinate values of an image output on the 3D image object 500 from each image output unit are stored. The render calculation unit 100a is configured to segment the 3D image object 500 according to the segmented region information 600, render the segmented 3D image object, and then transmit the rendered segmented 3D image object to the image output unit connected thereto.

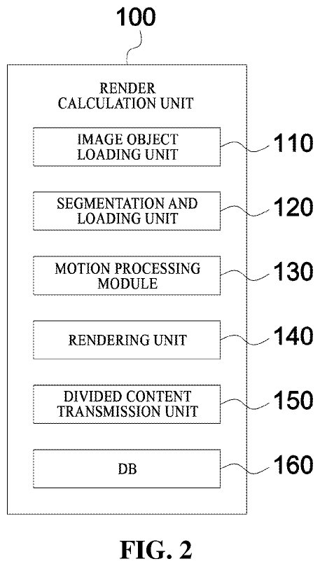

Each of the render calculation units 100a, 100b, 100c, . . . includes an image object loading unit 110, a dividing and loading unit 120, a motion processing module 130, a rendering unit 140, a segmented content transmission unit 150, and a database (DB) 160 as illustrated in FIG. 2. The component with a letter added to the identification number of the above component refers to a component as a specific render calculation unit 100b (e.g., the rendering unit 140b, the DB 160b, etc.), and the component with no letter (identification number consisting only of numbers) refers to a component including all of the render calculation units 100a, 100b, 100c, . . . (e.g., the rendering units 140a, 40b, 140c, . . . as the rendering unit 140).

In the DB 160, the 3D image object 500 and the segmented region information 600 are stored. In addition, motion command information 700 matched with specific motion information is also stored.

When a central point on the screen of the image output unit located at a center of the output unit 200 is a point of origin, the segmented region information 600 is composed of 3D coordinates for three of four corners on the screen of the image output unit connected to the render calculation unit.

Referring to FIG. 4, when a center of a second image output unit 200b among three image output units connected in a horizontal line is set as a point of origin of coordinates (0,0,0), segmented region information 600b of the second image output unit 200b includes a point Pc2 of coordinates (−8,5,0) in an upper left, a point Pa2 of coordinates (−8,−5,0) in a lower left, and a point Pb2 of coordinates (8,−5,0) in a lower right.

Divided region information 600a of a first image output unit 200a includes a point Pc1 of coordinates (−22,5,8) in an upper left, a point Pa1 of coordinates (−22,−5,8) in a lower left, and a point PH of coordinates (−8,−5,0) in a lower right and, similarly, segmented region information 600c of a third image output unit 200c includes a point Pc3 of coordinates (8,5,0) in an upper left, a point Pa3 of coordinates (8,−5,0) in a lower left, and a point Pb3 of coordinates (22,−5,8) in a lower right.

The 3D image object 500 includes environment information 510 including geographic information 511 corresponding to an entire background of the 3D image object 500, structure information 512 disposed in the geographic information 511, object information 513 disposed inside and outside the structure information 512, and lighting information 514 provided by a light source. The above configuration is to change data for each piece of environment information during the rendering.

The motion command information 700 is command data that is matched with specific motion information to induce a change of the 3D image object 500. For example, motion command information of “turn on indoor lighting” may be matched with motion information of “raising one hand,” motion command information of “turn off indoor lighting” may be matched with motion information of “raising two hands,” motion command information of “move a position of a specific object according to a direction of movement of a hand” may be matched with motion information of “moving one hand left or right,” and motion command information of “change a viewpoint of a currently visible screen according to a direction of a head turning” may be matched with motion information of “turning a head.”

The image object loading unit 110 serves to load the 3D image object 500 stored in the DB 160. In particular, a target extraction unit 111 which extracts the loaded 3D image object 500 for each piece of the environment information 510 may be further included, and the target extraction units 111 separately extract each piece of the geographic information 511, the structure information 512, the object information 513, and the lighting information 514.

The dividing and loading unit 120 serves to load the segmented region information 600 stored in the DB 160. In the embodiment of FIG. 4, the first render calculation unit 100a loads the segmented region information 600a composed of the point Pc1 of coordinates (−22,5,8), the point Pa1 of coordinates (−22,−5,8), and the point PH of coordinates (−8,−5,0) and, similarly, the second render calculation unit 100b and the third render calculation unit 100c load the segmented region information 600b and the segmented region information 600c, respectively.

The motion processing module 130 serves to receive the motion information to load the motion command information matched with the corresponding motion information from the DB 160, and the motion processing module 130 includes a motion information receiving unit 131 and a motion command information generating unit 132.

The motion information receiving unit 131 receives the motion information from the motion capture unit 300, and the motion command information generating unit 132 retrieves the motion information received by the motion information receiving unit 131 from the DB 160 and loads motion command information 700 matched with the motion information. For example, when the motion information of “raising one hand” is received, the motion command information of “turn on indoor lighting” is loaded.

The rendering unit 140 serves to segment the 3D image object 500 according to the segmented region information 600 and render the 3D image object segmented based on the motion command information 700, and the rendering unit 140 includes a screen splitter 141, a motion command information processing unit 142, a synchronization unit 143, and a GPU parallel processing unit 144 as illustrated in FIG. 2.

When a center of the 3D image object 500 is set as a point of origin of coordinates (0,0,0), the screen splitter 141 extracts the 3D image object segmented into a rectangular region composed of coordinates of the segmented region information 600. In the embodiment of FIG. 4, the first render calculation unit 100a extracts a rectangular region having the point Pc1 of coordinates (−22,5,8), the point Pa1 of coordinates (−22,−5,8), and the point Pb1 of coordinates (−8,−5,0) of the 3D image object 500 as three corners, the second render calculation unit 100b extracts a rectangular region having the coordinates of the segmented region information 600b as three corners, and the third render calculation unit 100c extracts a rectangular region having the coordinates of the segmented region information 600c as three corners.

The motion command information processing unit 142 serves to generate rendering information for rendering the 3D image object based on the motion command information 700. For example, rendering information to change the illuminance setting of the segmented 3D image object is generated according to the motion command information of “turn on indoor lighting,” rendering information to extract and move a specific object is generated according to the motion command information of “move a position of a specific object according to a direction of movement of a hand,” or rendering information to change the camera viewpoint setting for rendering the 3D image object 500 is generated according to the motion command information of “change a viewpoint of a currently visible screen according to a direction of a head turning.”

When the corresponding render calculation unit is the client, the synchronization unit 143 serves to transmit the rendering data generated by the motion command information processing unit 142 to the server, and when the render calculation unit is the server, the synchronization unit 143 serves to transmit the rendering information generated by the motion command information processing unit 142 or the rendering information transmitted from another render calculation unit to the remaining render calculation units.

In the embodiment of FIG. 4, a case in which the first render calculation unit 100a is the server and the second render calculation unit 100b and the third render calculation unit 100c are the clients will be described as follows.

When the motion command information processing unit 142 of the first render calculation unit 100a generates rendering information, the generated rendering information is transmitted to the second and third render calculation units 100b and 100c, which are clients. In contrast, when the motion command information processing unit 142 of the second render calculation unit 100b generates rendering information, the generated rendering information is transmitted to the first render calculation unit 100a, wherein the first render calculation unit 100a receives the generated rendering information and transmits the generated rendering information to another client, that is, the third render calculation unit 100c. Therefore, all of the render calculation units may have synchronized rendering information.

The synchronization unit 143 uses the rendering information transmitted by the synchronization unit 143 to render the 3D image object 500 using a parallel GUP computing method. That is, many pieces of environment information may be processed in real time by rendering in parallel using a GPU. Therefore, as illustrated in FIG. 3, a plurality of GPUs should be built-in so that the render calculation units may perform parallel GUP computing.

The segmented content transmission unit 150 serves to transmit the segmented 3D image object rendered by the rendering unit 140 to the image output unit connected to the render calculation unit. That is, the first render calculation unit 100a transmits the segmented 3D image object to the first image output unit 200a, and the second render calculation unit 100b transmits the segmented 3D image object to the second image output unit 200b.

While the exemplary embodiments of the present invention described above are given for the purpose of describing the embodiments, it will be understood by those skilled in the art that various modifications, changes, and additions may be made within the spirit and scope of the present invention. Such modifications, changes, and additions should be regarded as falling within the scope of the appended claims.

It will be understood by those skilled in the art that various replacements, changes, and modifications may be made without departing from the scope of the present invention. Therefore, the present invention is not limited by the above-described embodiments of the present invention and the accompanying drawings.

In the exemplary system described above, the methods are described based on flowcharts as a series of operations or blocks, but the present invention is not limited to the order of the operations, and certain operations may be performed in a different order from or simultaneously performed with the operations described above. In addition, it will be understood by those skilled in the art that the operations illustrated in the flowcharts are not exclusive, and other operations may be included, or one or more operations may be deleted without affecting the scope of the present invention.

### INDUSTRIAL APPLICABILITY

According to the present invention, a motion capture image can be rendered in real time.

Further, content can be produced using a hologram or the like from the image rendered as described above.

Further, ultra-high resolution three-dimensional (3D) image content can be rendered in real time using a parallel graphics processing unit (GPU) computing technique, and a system that enables interactions through recognition of a motion of a user can be provided, thereby improving immersion.

1. A system for performing real-time parallel rendering of a motion capture image using a graphics processing unit (GPU).
